(19) United States
(12) Patent Application Publication
(10) Pub. No.: US 2010/0206888 A1
(43) Pub. Date: Aug. 19, 2010

(54) TEMPERATURE CONTROL DEVICE

(75) Inventors: Benjamin Boebst, Mittelbiberach (DE); Frank Boettger, Ravensburg (DE)

Correspondence Address: HARNESS, DICKEY & PIERCE, P.L.C., P.O. BOX 828, BLOOMFIELD HILLS, MI, 48303, US

(73) Assignee: Arzneimittel GmbH Apotheker Vetter & Co. Ravensbur g, Ravensburg (DE)

(21) Appl. No.: 12/675,335

(22) PCT Filed: Aug. 9, 2008
(86) PCT No.: PCT/EP08/06593

§ 371 Date: Feb. 25, 2010

(30) Foreign Application Priority Data
Aug. 28, 2007 (DE) 10 2007 040 487.7

(51) Int. Cl. B65D 81/38; F28D 15/00; F24H 9/00; G05D 23/00

(52) U.S. Cl. 220/592.01; 165/104.19; 165/56; 165/287

(57) ABSTRACT

A temperature control device (1) for pharmaceutical solution containers (13) is proposed, having at least one wall section (3) into which a medium that can be temperature-controlled can be introduced. It is characterized in that it can be attached to the solution container (13) on the outside, and can be detached from it again.

The invention relates to a temperature control device in accordance with the preamble of claim 1.

Temperature control devices of the type being discussed here are known. They are particularly used for pharmaceutical solution containers, in which solutions are mixed or solids are dissolved in solvents, preferably in water, particularly in preparation for sterile filtration. In this connection, the temperature of the solution contained in the pharmaceutical solution container is of particular importance, since it influences the solubility of solids in a solvent, for example. The temperature can also influence the stability of the components that occur in the solution. Dissolving solids in solvents and mixing solutions is carried out in solution containers in the form of pressurized containers or boilers. In this connection, temperature control of the solution takes place by means of double-mantled solution containers. Such solution containers have two wall regions disposed concentric to one another, where the solution to be mixed or the solvent intended for dissolving a solid, respectively, can be introduced into the chamber delimited by the first wall region. A medium suitable for temperature control is introduced into the chamber delimited by the second wall region, the temperature of which medium is preferably regulated by means of a thermostat. The temperature of the medium that can be temperature-controlled is transferred to the medium contained in the solution container by way of the first wall region. Such double-mantled pharmaceutical solution containers have the disadvantage that they are very complicated and therefore very expensive to produce. Another disadvantage of such solution containers is their complicated cleaning. Furthermore, there is the risk that the medium that can be temperature-controlled, which is disposed between the first and the second wall region, might come into contact with the pharmaceutical solution. In any case, contamination of the pharmaceutical solution in the solution container cannot be completely excluded.

It is therefore the task of the invention to create a temperature control device for a pharmaceutical solution container, which device avoids the aforementioned disadvantages.

To accomplish this task, a temperature control device for pharmaceutical solution containers is proposed, which has the characteristics indicated in claim 1. The temperature control device has at least one wall section into which a medium that can be temperature-controlled can be introduced. It is characterized in that it can be attached to the solution container on the outside, and can be detached from it again. This embodiment of a temperature control device offers the advantage that in the production of pharmaceutical solution containers that need a temperature control device, the production costs can be significantly reduced, since the tremendous production effort of the double mantling is eliminated. The temperature control device proposed here can be used, in advantageous manner, in conventional pharmaceutical solution containers of the most varied sizes and shapes. It is possible, for example, to lay them around the solution container like a mantle, and to detach them from the solution container again after completion of the temperature control process. Because of the fact that the medium that can be temperature-controlled is provided in at least one wall section, contamination with the solution contained in the solution container is precluded. The temperature control device can be configured for use in sterile spaces, also as a disposable temperature control device. Because of the elimination of the double mantling of a pharmaceutical solution container, the weight of this container is furthermore significantly reduced.

A temperature control device that is characterized in that it has at least one inlet and at least one outlet is particularly preferred. In this connection, the at least one inlet and the at least one outlet open into the at least one wall section into which the medium that can be temperature-controlled, referred to hereinafter simply as medium, can be introduced. A medium can thus be introduced into the wall section by way of the inlet, and can be passed out again by way of the outlet.

Furthermore, a temperature control device that is characterized in that the temperature control device has a thermostat is preferred. The medium that can be introduced into the at least one wall section of the temperature control device can be heated or cooled to a specific temperature by means of the thermostat.

Also, a temperature control device that is characterized in that at least the at least one wall section has a temperature-resistant material or consists of such a material is preferred. By means of this advantageous embodiment, it is guaranteed that even in the event of great heating or cooling of the medium contained in the wall section, the temperature control device will not be damaged.

A temperature control device that can be attached to the pharmaceutical solution container with at least one belt and/or at least one hook and loop closure is preferred. In this manner, the temperature control device can be very easily attached to the conventional solution container and detached again. However, the temperature control device can also be attached to a pharmaceutical solution container in different manner, using simple means. In particular, it can be provided that the temperature device has an excess pressure device, by means of which the at least one wall section of the temperature control device, in particular, can be adapted to the solution container. In the event of activation of the excess pressure device, the inside diameter of the temperature control device changes, and the device finally adapts itself to the circumference of the pharmaceutical solution container in such a manner that the temperature control device lies firmly against the solution container.

Furthermore, a temperature control device that is characterized in that water, alcohol and/or silicone oil can be used as a medium that can be temperature-controlled is preferred. For a specific medium, it is then only necessary to structure the temperature control device in such a manner that it is stable, in terms of its properties, with regard to the medium used.

Also, a temperature control device in which at least the at least one wall section is structured to be flexible is preferred. By means of the flexibility of the temperature control device, at least in certain regions, it is advantageously possible to use it for solution containers having different shapes. Also, it is possible to provide a prefilled temperature control device that only has to be connected with a thermostat or the like, by way of a corresponding connector. In particular, it can be provided that the temperature control device demonstrates a flexible plastic or consists of one, at least in certain regions. The use of flexible plastic offers the advantage that the temperature control device is flexible in use, on the one hand, and advantageous to produce, on the other hand.

Furthermore, a temperature control device that is characterized in that the at least one wall section is structured in rib form, to implement channels, is preferred. In particular, a channel configured in the manner of a serpentine line is provided, through which a medium flows.

Also, a temperature control device that is characterized in that an inside of the temperature control device that lies against the solution container has a smooth surface is preferred. By means of this advantageous configuration, particularly good heat transfer from the temperature control device to the pharmaceutical solution container is possible.

Furthermore, a temperature control device that can be γ-sterilized and/or steam-sterilized is particularly preferred. This advantageous embodiment makes it possible to use the temperature control device multiple times, for example for use in sterile spaces.

Also, a temperature control device on which multiple inlets and outlets are provided is preferred. In this connection, the multiple inlets and outlets preferably interact with multiple wall sections that are separated from one another.

In another preferred temperature control device, circulation of the medium is brought about in the at least one wall section. In this connection, it is provided that the medium flows from the inlet of the at least one wall section to its outlet, and thus circulation in the wall section is brought about. Preferably, multiple wall sections separated from one another are provided, which serve to accommodate a medium that can be temperature-controlled. It is also possible to introduce different media that can be temperature-controlled into the separate wall sections. Preferably, separate circulation of the medium to be temperature-controlled is brought about in each of the wall sections.

Furthermore, a temperature control device that is characterized in that its inside, which lies against the solution container, consists of a heat-conductive material or is coated with such a material is preferred. Furthermore, the outside of the temperature control device, which lies opposite the inside, in other words facing away from the solution container, preferably consists of an insulating material or is coated with such a material. This embodiment offers the advantage that on the one hand, little heat is given off to the surroundings of the temperature control device, and on the other hand, good heat transfer between the temperature control device and the pharmaceutical solution container exists.

Finally, a temperature control device in which the at least one wall section is configured in multiple layers is preferred. Thus, for example, in a wall section that contains a medium, a layer disposed parallel to the former can be provided, into which compressed air, for example, can be introduced, to implement an excess pressure device.

The invention will be explained in greater detail in the following, using drawings. These show:

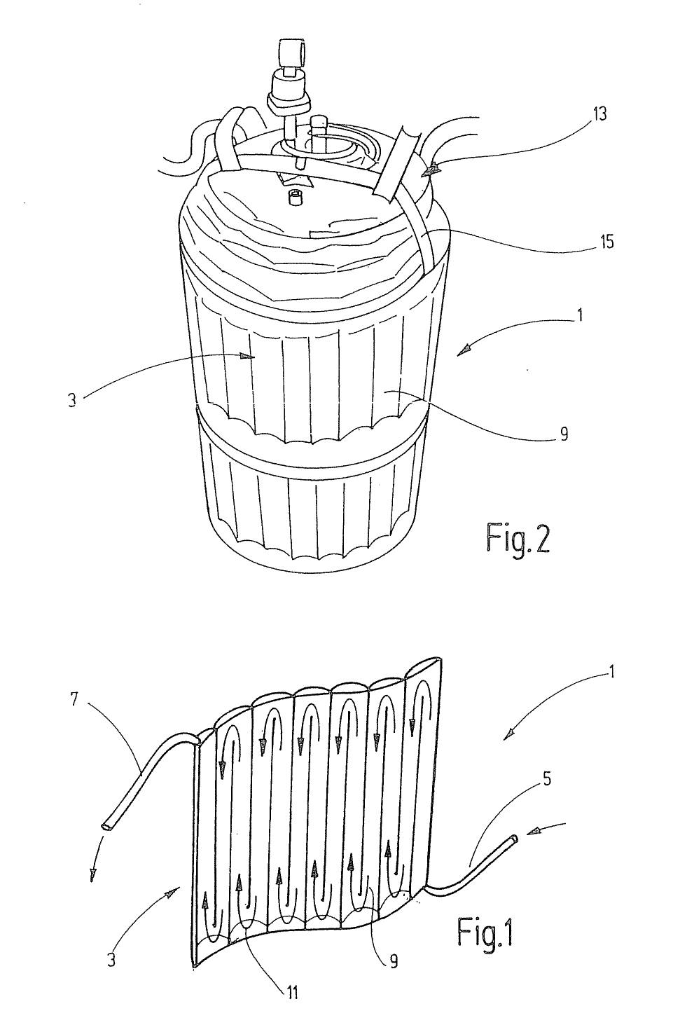

FIG. 1 a schematic representation of a temperature control device for pharmaceutical solution containers;

FIG. 2 an exemplary embodiment of a temperature control device, and

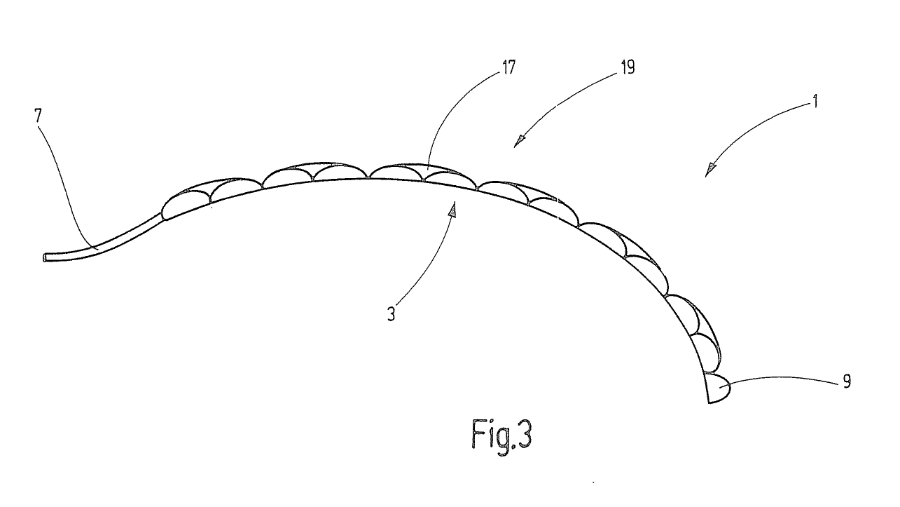

FIG. 3 a schematic representation of a temperature control device in a top view.

FIG. 1 shows a perspective representation of a temperature control device 1 for pharmaceutical solution containers, having at least one wall section 3, into which a medium that can be temperature-controlled can be introduced.

The at least one wall section 3 extends over the entire area of the temperature control device 1 here. However, it can also be provided that the wall section 3 extends only in one region of the temperature control device 1. The temperature control device 1 has at least one inlet 5 and at least one outlet 7, which stand in a fluid connection with the at least one wall section 3.

A medium that can be temperature-controlled, such as water and/or alcohol and/or silicone oil, for example, can be introduced into the wall section 3 through the inlet 5. The temperature control device 1 preferably interacts with a thermostat, not shown here, which regulates the temperature of the medium that can be temperature-controlled and is contained in the wall section 3.

At least the at least one wall section 3 of the temperature control device 1 preferably demonstrates a temperature-resistant material or consists of such a material, so that damage to the temperature control device 1 in the event of temperature control of the medium contained in the wall section 3 to very high or also to very low temperatures is precluded.

FIG. 1 makes it clear that the at least one wall section 3 is configured in rib shape. In the temperature control device 1 shown here, the ribs are connected with one another, in a serpentine line, in such a manner that a channel 9 is formed in the wall section 3, which channel reaches from the inlet 5 to the outlet 7. A medium that gets into the at least one wall section 3 by way of the inlet 5 is guided in the channel 9 in the direction of the arrows 11, and finally passed out of the wall section 3 by way of the outlet 7.

The medium gets from the outlet 7 preferably to the temperature regulator, not shown here, particularly to a thermostat. Therefore a circulation of the medium that can be temperature-controlled, from the thermostat to the wall section 3, by way of the inlet 5 and by way of the outlet 7, back to the thermostat, is formed. The medium circulates in the wall section 3, where the thermostat ensures that the medium has a desired temperature.

The channel 9 in the at least one wall section 3 can be implemented in different ways, and can have different shapes, i.e. progressions of the wall section 3. The serpentine line shape of the channel 9 can run perpendicular with reference to a solution container, or also horizontal to it.

Preferably, the temperature control device 1 has multiple wall sections 3, in which a channel 9 is formed, in each instance. In this manner, the temperature control device 1 has multiple channels 9 disposed separated from one another, each of which has its own inlet 5 and its own outlet 7. Thus, a separate circulation of medium that can be temperature-controlled is present in every wall section 3.

The formation of multiple wall sections 3, each of which has an inlet and an outlet and thus its own circulation, prevents a medium from changing its temperature too greatly on its path through a wall section 3. This can particularly be the case if the path through the wall section is too long. Preferably, for this reason, multiple wall sections 3 are provided, in which the medium only needs to travel a shorter distance until it arrives at the thermostat again.

It can also be provided to configure multiple wall sections 3 into which different media are introduced. The temperature control device 1 can also have sensors that measure the temperature of the medium contained in the wall section 3 at any desired location in the temperature control device 1, or even outside of it.

FIG. 2 shows an embodiment of a temperature control device 1. The same parts are provided with the same reference symbols, so that in this regard, reference is made to the description of FIG. 1.

FIG. 1 shows a solution container 13 that is surrounded by a temperature control device 1. The solution container 13 preferably serves for mixing solutions or for dissolving solids in solvents, such as water, for example. It is furthermore supposed to be possible to store the resulting pharmaceutical solution in the solution container 13 at a specific temperature. The temperature control device 1 proposed here is advantageously suitable for this purpose.

The temperature control device 1 is preferably structured to be flexible, for example composed of a flexible plastic, and can thereby be flexibly adapted to different shapes and sizes of solution containers 13.

The temperature control device 1 can be attached to the solution container 13 in different ways. In the exemplary embodiment shown here, the temperature control device 1 is attached to the solution container 13 by means of a belt 15. The belt 15 can be worked into the temperature control device 1 and is preferably provided with a hook and loop closure, not shown here, which allows particularly easy fastening of the temperature control device 1 to the solution container 13.

A hook and loop closure can also be provided directly on the temperature control device 1, without a belt. The belt 15 shown here is indicated purely as an example; a fastening device for the temperature control device 1 proposed here can be implemented in different ways. The decisive factor is that the temperature control device 1 can be attached to a solution container 13 in simple manner, and can be detached from the solution container 13 again in simple manner.

An excess pressure device, not shown here, can also be provided for implementing a fastening device, which changes the shape of the temperature control device 1 in such a manner that it adapts itself to the shape and/or the size of any desired solution container. This will be discussed in greater detail below.

FIG. 2 makes it clear, as was already explained above, that the temperature control device 1 is preferably structured in flexible manner; in particular, it demonstrates a flexible plastic or consists of one, at least in certain regions. This embodiment of the temperature control device 1 also allows particularly flexible adaptation to the most varied solution containers. It is understood that the present invention is not restricted to the temperature control device 1 shown here, but rather this device can also be configured as desired, in terms of shape and size. Here, the temperature control device 1 can be disposed around a solution container 13, essentially like a mantle, and can be attached to the container by means of a suitable fastening device. However, a closed embodiment of the temperature control device 1 is also possible, so that it can be set onto a solution container, for example.

The inside of the temperature control device 1, which lies against the solution container 13, preferably has a smooth surface, at least in the region of the at least one wall section 3, so that a particularly large contact surface of the temperature control device 1 on the solution container 13 results, thereby making the temperature transfer from the at least one wall section 3 to the solution container 13 particularly good. The temperature control device 1 is preferably configured in such a manner that it can be γ-sterilized and/or steam-sterilized, which makes it advantageously possible to use the temperature control device 1 multiple times, particularly in a sterile environment.

Preferably, it is provided that the inside of the temperature control device 1, which lies against the solution container 13, at least in the region of the at least one wall section 3, consists of a heat-conductive material or is coated with such a material. In this manner, the temperature transfer between the temperature control device 1 and the solution container 13 can be significantly improved. It can also be provided that the outside of the temperature control device 1, which lies opposite the inside and faces away from the solution container 13, is produced from an insulating material or coated with such a material. The temperature control of the pharmaceutical solution contained in the solution container 13 is further improved in that temperature equalization between the temperature-controlled medium contained in the wall section 3 and the surroundings is reduced.

FIG. 3 shows a schematic representation of another embodiment of a temperature control device 1 in a top view. The same parts are provided with the same reference symbols, so that in this regard, reference is made to the description of the previous figures.

FIG. 3 shows a temperature control device 1 in which the at least one wall section 3 is structured in multiple layers. In particular, it is provided that because of the multi-layer configuration of the wall section 3, at least one channel 17 is formed, into which a medium can be introduced. The channel 17 preferably has an access, not shown here. The at least one channel 17 can be provided for the purpose of accommodating compressed air, for example, to implement an excess pressure device 19.

The excess pressure device 19 can be implemented in such a manner that compressed air can be introduced into multiple channels 17 formed by means of a multi-layer configuration of the temperature control device 1. When the temperature control device 1 is supposed to be attached to a solution container 13, compressed air can be introduced into the channels 17, by way of the access, thereby causing the channels 17 to widen and the temperature control device 1 to become smaller in its inside diameter. In the event that the temperature control device 1 is no longer needed, the air can be let out of the channels 17 again. The inside diameter of the temperature control device 17 then increases, and the temperature control device can be detached from the solution container 13. However, the excess pressure device 19 can also be implemented by means of a different suitable medium that can be introduced into the channel 17.

For use in sterile spaces, the temperature control device 1 is preferably structured so that it can be γ-sterilized and/or steam-sterilized. However, it can also be provided to provide the temperature control device 1 as a disposable temperature control device that is disposed of after one-time use, in order to guarantee sterility of a sterile space.

The temperature control device 1 can be prefilled, so that only a corresponding temperature regulation device has to be connected with the inlet and with the outlet, respectively, in order to make the temperature control device 1 ready for operation. The temperature control device 1 can be structured in different shapes and sizes. As has already been explained, it is also possible to provide multiple wall sections 3, disposed separate from one another, with separate inlets and outlets.

The temperature control device 1 proposed here offers the advantage that a conventional solution container 13, without double mantling, having the most varied shape and size, can be stored so that it can be temperature-controlled, without requiring a double-mantle solution container, which is complicated to produce, for this purpose. Furthermore, the temperature control device 1 proposed here can be produced in particularly cost-advantageous manner. Contamination of the pharmaceutical medium contained in the solution container 13 with the medium contained in the temperature control device 1, which medium can be temperature-controlled, is furthermore excluded by the temperature control device 1 proposed here, structured to be separate from the solution container 13. Furthermore, the complicated cleaning process of the known dual-chamber solution container is completely eliminated.

The temperature control device 1 can advantageously be attached to a solution container 13 in simple manner, and can be detached from the solution container 13 again after completion of the temperature control process.

1-17. (canceled)

18. A temperature control device for pharmaceutical solution containers comprising: at least one wall section into which a medium that can be temperature-controlled can be introduced, wherein the device can be releasably attached to the solution container on an outside thereof.

19. The temperature control device according to claim 18, wherein the device has at least one inlet and at least one outlet that open into the at least one wall section.

20. The temperature control device according to claim 18, further comprising a thermostat.

21. The temperature control device according to claim 18, wherein at least the at least one wall section is at least partially constructed of a temperature-resistant material.

22. The temperature control device according to claim 18, wherein the device is attachable to the solution container with a fastening arrangement selected from a group including at least one belt; and at least one hook and loop closure.

23. The temperature control device according to claim 18, further comprising an excess pressure device allowing the at least one wall section to be adapted to the solution container.

24. The temperature control device according to claim 18, wherein the medium is selected from a group including water, alcohol and silicone oil.

25. The temperature control device according to claim 18, wherein at least the at least one wall section is flexible.

26. The temperature control device according to claim 18, wherein the device is at least partially constructed of flexible plastic.

27. The temperature control device according to claim 18, wherein the at least one wall section is configured in rib shape to define channels.

28. The temperature control device according to claim 18, wherein an inside of the temperature control device to be positioned proximate the solution container has a smooth surface.

29. The temperature control device according to claim 18, wherein the device can be γ-sterilized and/or steam-sterilized.

30. The temperature control device according to claim 18, further comprising multiple inlets and outlets.

31. The temperature control device according to claim 18, wherein a circulation of the medium that can be temperature-controlled is brought about in the at least one wall section.

32. The temperature control device according to claim 18, wherein an inside of the device adapted to lie adjacent the solution container includes a heat-conductive material and an outside, which lies opposite the inside and faces away from the solution container, includes an insulating material.

33. The temperature control device according to claim 18, wherein the at least one wall section includes multiple wall sections, separated from one another, which serve to accommodate the medium.

34. The temperature control device according to claim 18, wherein the at least one wall section is configured in multiple layers.

35. The temperature control device according to claim 18, in combination with the solution container.

36. A pharmaceutical solution container in combination with a temperature control device, the temperature control device comprising:
at least one wall section;
a temperature-controlled medium within the at least one wall section; and
a fastening arrangement for releasably securing the temperature control device to the container.

37. The combination of claim 36, wherein the container includes an arcuate sidewall and the temperature control device flexibly adapts to the sidewall.
